(19) United States
(12) Patent Application Publication
(10) Pub. No.: US 2023/0375209 A1
(43) Pub. Date: Nov. 23, 2023

(54) HYDRAULIC MODULE CONTROL SYSTEM OF FLOOR HEATING MULTI-SPLIT AIR CONDITIONER AND CONTROL METHOD THEREOF

(71) Applicant: Carrier Corporation, Palm Beach Gardens, FL (US)

(72) Inventors: Yingbiao Liang, Foshan (CN); Long Xiong, Foshan (CN)

(21) Appl. No.: 18/318,179

(22) Filed: May 16, 2023

(30) Foreign Application Priority Data
May 18, 2022 (CN) 202210552018.7

(51) Int. Cl. F24F 11/67; F24F 11/84; F24F 11/85; F24F 11/77; F24D 3/14; F24D 19/10

(52) U.S. Cl. CPC F24F 11/67; F24F 11/84; F24F 11/85; F24F 11/77; F24D 3/14; F24D 19/1024; F24F 2221/34; F24F 2120/10

(57) ABSTRACT

A hydraulic module control system of a floor heating multi-split air conditioner and a control method of the hydraulic module control system. The system includes: a plurality of temperature controllers, in signal connection with the hydraulic module, and configured to set a set temperature in each room and an operation mode of the hydraulic module; and a control module, in signal connection with the hydraulic module, and configured to: set preset water outlet temperature values under the different operation modes of the hydraulic module; and control the hydraulic module to operate according to received operation modes set by the temperature controllers and preset water outlet temperature values corresponding to the set temperatures, and control the operation mode of the hydraulic module according to a comparison result of an outdoor ambient temperature and a first temperature preset value when both a cooling operation mode and a heating operation mode are received.

### CROSS REFERENCE TO RELATED APPLICATIONS

This application claims priority to Chinese Patent Application No. CN202210552018.7 filed on May 18, 2022.

### TECHNICAL FIELD

The present invention relates to the technical field of air conditioners, in particular to an air conditioning system for a bypass heating gas-liquid separator and a heating method thereof.

### BACKGROUND

In the field of air conditioners, multiple temperature zones are very common, the temperature output to a terminal of an air conditioning system may be precisely controlled through an electronic expansion valve, and then different temperature zones are achieved through air supplying of an indoor fan. However, in a water system, controlling the water flow cannot change the temperature of water per se, and the heat exchange effect of floor heating is relatively fixed. For a system having a plurality of temperature zones, the implementation of the water system is more complex.

### SUMMARY

For the above problems, the present invention provides a simple hydraulic module control system of a floor heating multi-split air conditioner and a control method of the hydraulic module control system. One hydraulic module controls cooling and heating requirements of a plurality of rooms, and meanwhile, different requirements of different rooms are met through a plurality of temperature controllers.

The present invention provides a hydraulic module control system of a floor heating multi-split air conditioner. The floor heating multi-split air conditioner includes a hydraulic module and a plurality of floor heating modules connected with the hydraulic module, and the plurality of floor heating modules are correspondingly arranged in a plurality of rooms. The hydraulic module control system includes: a control module and a plurality of temperature controllers corresponding to the plurality of rooms. The temperature controllers are in signal connection with the hydraulic module, and are configured to set a set temperature in each room and a operation mode of the hydraulic module. The control module is in signal connection with the hydraulic module, and is configured to: set preset water outlet temperature values under the different operation modes of the hydraulic module; and control the hydraulic module to operate according to received operation modes set by the temperature controllers and the set temperatures, and control the hydraulic module to operate in a cooling mode or a heating mode preferentially according to a comparison result of an outdoor ambient temperature and a first temperature preset value when both a cooling operation mode and a heating operation mode are received.

According to the technical solution, in the present invention, one hydraulic module corresponds to the plurality of floor heating modules, through connection and control manners of the temperature controllers in the rooms and the hydraulic module as well as the control module and the hydraulic module, the temperature in each room is independently controlled, the system structure is simplified, the system cost is lowered, and cooling and heating are achieved through water circulation to improve the comfort of the system; and when different cooling/heating requirements of different rooms are received, the operation mode that is selected preferentially is judged in combination with the outdoor ambient temperature, so that different requirements of different rooms are met while the system energy consumption is lowered.

In an optional technical solution of the present invention, the hydraulic module includes a water inlet pipe, a water outlet pipe, a master two-way valve, a master three-way valve and a water tank, inlet ends of the floor heating modules communicate with the water outlet pipe, outlet ends of the floor heating modules communicate with the water inlet pipe, and each floor heating module is provided with a separate valve element. The master three-way valve is connected with the water outlet pipe, the water tank and the inlet ends of the plurality of floor heating modules. The master two-way valve is connected with the outlet ends of the plurality of floor heating modules and the water inlet pipe. The hydraulic module further includes a hydraulic heat exchanger, a built-in water pump, an electric heating unit and an external water pump, the hydraulic heat exchanger includes a first joint connected with an outdoor unit high-pressure air pipe, a second joint connected with an outdoor unit liquid pipe, a third joint connected with the built-in water pump and a fourth joint connected with the electric heating unit, an inlet of the built-in water pump is connected with the water inlet pipe, an outlet of the electric heating unit is connected with the water outlet pipe, and the external water pump is arranged between the outlet end and the master two-way valve.

According to the technical solution, the hydraulic module of the floor heating multi-split air conditioner of the present invention is simple in structure, which is conductive to lowering the cost.

In an optional technical solution of the present invention, when the hydraulic module operates in the cooling mode, the built-in water pump and the external water pump are controlled to be started, the separate valve elements corresponding to a heating room and a shut-down room respectively are controlled to be closed, and the separate valve element corresponding to a cooling room is controlled to be opened.

When the hydraulic module operates in the heating mode, the built-in water pump and the external water pump are controlled to be started, the separate valve elements corresponding to the cooling room and the shut-down room respectively are controlled to be closed, and the separate valve element corresponding to the heating room is controlled to be opened.

According to the technical solution, in different modes, the room temperature in each room may be controlled through opening and closing of the separate valve elements according to the cooling and heating requirements of the different rooms, so that a plurality of temperature zones are controlled respectively.

In an optional technical solution of the present invention, a temperature detection module is further included, and is configured to detect a room temperature in each room.

The control module is configured to: control opening and closing of the separate valve element in each room according to a comparison result of the room temperature in each room and the corresponding set temperature, and control the hydraulic module to shut down when the room temperatures in all the rooms reach the set temperature.

According to the technical solution, when the room temperatures reach the set temperature, the separate valve elements are closed to lower energy consumption output of the hydraulic module, which is conductive to saving the energy consumption; and when all the room temperatures reach the set temperature, the hydraulic module is shut down, which is conductive to lowering the system energy consumption and improving the economy.

In an optional technical solution of the present invention, when a difference value between the room temperature in each room and the set temperature is greater than a second temperature preset value and lasts for a predetermined period of time, the temperature controller in the room sends a request to the hydraulic module, and the hydraulic module is controlled to increase the amount of heating/cooling by modifying a set temperature correction value and controlling the built-in water pump to be fixed to a maximum gear.

According to the technical solution, the amount of cooling or heating is increased by modifying the set temperature correction value and fixing the built-in water pump to the maximum gear, so that the water temperature increasing or decreasing rate can be increased to meet user requirements.

In an optional technical solution of the present invention, an infrared detector is further included, and is configured to detect whether a person is in each room, and the control module adjusts the set temperature or controls starting and shutdown of the hydraulic module according to a detection result of the infrared detector.

According to the technical solution, by judging whether a person is in a room, the set temperature is adjusted or starting and shutdown of the hydraulic module are controlled, which is conductive to saving the energy consumption and improving the economy.

In an optional technical solution of the present invention, an ambient brightness detection module is further included, and is configured to detect brightness in each room, and the control module controls a rotating speed of an indoor fan of the floor heating multi-split air conditioner, a rotating speed of the built-in water pump and a rotating speed of the external water pump according to a brightness detection result of the ambient brightness detection module.

According to the technical solution, when the brightness of a room is lower than a regulated value, the rotating speed of the indoor fan, the rotating speed of the built-in water pump and the rotating speed of the external water pump are lowered, which is conductive to further saving energy consumption and improving the system economy.

In an optional technical solution of the present invention, the control module is further configured to: set starting time and a starting period of a domestic hot water mode operated by the hydraulic module, and control the master two-way valve and the external water pump to be closed and shut down and control the master three-way valve to be opened during the starting time.

According to the technical solution, the domestic hot water mode may be operated regularly according to needs to obtain domestic hot water, and the use convenience is improved; and manual intervention is reduced.

The present invention additionally provides a control method of the above hydraulic module control system of the floor heating multi-split air conditioner, including the following steps:
setting a set temperature in each room and an operation mode of a hydraulic module;
setting preset water outlet temperature values under a cooling mode and/or a heating mode of the hydraulic module; and controlling the hydraulic module to operate according to operation modes set by temperature controllers and preset water outlet temperature values corresponding to the set temperatures, and controlling the cooling mode or the heating mode to be operated preferentially according to a comparison result of an outdoor ambient temperature and a third temperature preset value when the hydraulic module simultaneously receives the operation modes of cooling and heating.

According to the present invention, through connection and control manners of the temperature controllers in the rooms and the hydraulic module as well as the control module and the hydraulic module, the temperature in each room is independently controlled, the system structure is simplified, the system cost is lowered, and cooling and heating are achieved through water circulation to improve the comfort of the system; and when different cooling/heating requirements of different rooms are received, the operation mode that is selected preferentially is judged in combination with the outdoor ambient temperature, so that different requirements of different rooms are met while the system energy consumption is lowered and system operating reliability is guaranteed.

### BRIEF DESCRIPTION OF THE DRAWINGS

FIG. 1 is a schematic structural diagram of a hydraulic module control system of a floor heating multi-split air conditioner in an implementation of the present invention.

FIG. 2 is a schematic structural diagram of a hydraulic module of a floor heating multi-split air conditioner in an implementation of the present invention.

FIG. 3 is a schematic structural diagram of a temperature controller in an implementation of the present invention.

In the figures the reference numerals refer to the following: Hydraulic module 1; water inlet pipe 11; water outlet pipe 12; master two-way valve 13; master three-way valve 14; water tank 15; hydraulic heat exchanger 16; built-in water pump 17; electric heating unit 18; external water pump 19; floor heating module 2; separate valve element 20; temperature controller 3; temperature detection module 31; infrared detector 32; ambient brightness detection module 33; and control module 4.

### DETAILED DESCRIPTION

The technical solution in embodiments of the present invention will be clearly and completely described below in combination with the accompanying drawings in the embodiments of the present invention. Apparently, the described embodiments are only part of the embodiments of the present invention, not all of them. The purpose of providing these implementations is to make the contents disclosed in the present invention understood more thoroughly and comprehensively. Based on the embodiments of the present invention, all other embodiments obtained by those of ordinary skill in the art without any creative work fall within the protection scope of the present invention.

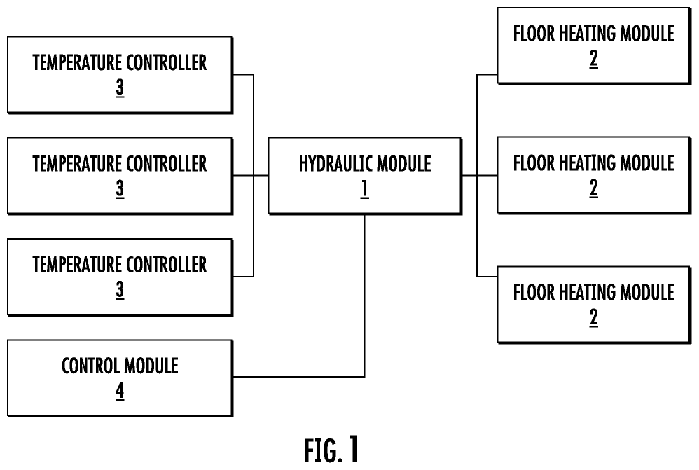

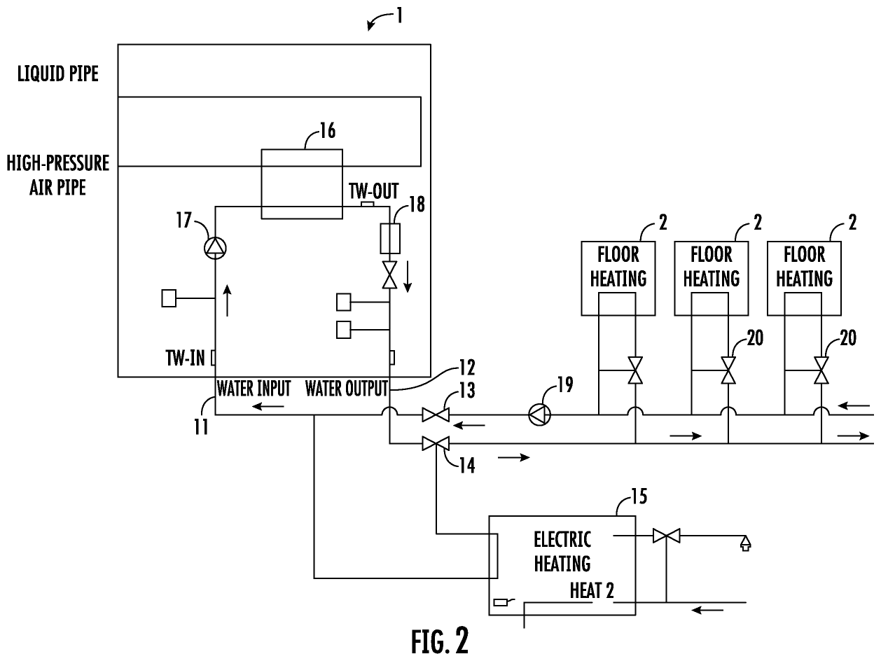

Referring to FIG. 1 and FIG. 2, the present invention provides a hydraulic module control system of a floor heating multi-split air conditioner. The floor heating multi-split air conditioner includes a hydraulic module 1 and a plurality of floor heating modules 2 connected with the hydraulic module 1, the plurality of floor heating modules 2 are arranged in a plurality of rooms in a one-to-one correspondence, and the floor heating modules 2 are specifically floor heating coil pipes arranged in the rooms. The hydraulic module control system includes: a control module and a plurality of temperature controllers corresponding to the plurality of rooms. The hydraulic module control system includes: a control module 4 and the plurality of temperature controllers 3 corresponding to the rooms. The temperature controllers 3 are in signal connection with the hydraulic module 1, and are configured to set a set temperature in each room (air temperature in each room) and a operation mode of the hydraulic module 1. The control module 4 is in signal connection with the hydraulic module 1, and is configured to: set preset water outlet temperature values under different operation modes (e.g., a cooling mode, a heating mode and a domestic hot water mode) of the hydraulic module 1; and control the hydraulic module 1 to operate according to received operation modes set by the temperature controllers 3 and preset water outlet temperature values corresponding to the set temperatures, and control the hydraulic module 1 to operate in the cooling mode or the heating mode preferentially according to a comparison result of an outdoor ambient temperature and a first temperature preset value when the both a cooling operation mode and a heating operation mode are received.

Through the above manner, according to the present invention, one hydraulic module 1 corresponds to the plurality of floor heating modules 2, and through connection and control manners of the temperature controllers 3 in the rooms and the hydraulic module 1 as well as the control module 4 and the hydraulic module 1, the temperature in each room is independently controlled, the system structure is simplified, the system cost is lowered, and cooling and heating are achieved through water circulation to improve the comfort of the system; and when different cooling/heating requirements of different rooms are received, the operation mode that is selected preferentially is judged in combination with the outdoor ambient temperature, so that different requirements of different rooms are met while the system energy consumption is lowered and system operating reliability is guaranteed; and the system operating reliability is guaranteed.

In a preferred implementation of the present invention, the hydraulic module 1 includes a water inlet pipe 11, a water outlet pipe 12, a master two-way valve 13, a master three-way valve 14 and a water tank 15, inlet ends of the floor heating coil pipes communicate with the water outlet pipe 12 of the hydraulic module 1, outlet ends of the floor heating coil pipes communicate with the water inlet pipe 11, and each floor heating coil pipe is provided with a separate valve element 20. The master three-way valve 14 is connected with the water outlet pipe 12, the water tank 15 and the inlet ends of the plurality of floor heating coil pipes. The master two-way valve 13 is connected with the outlet ends of the plurality of floor heating modules 2 and the water inlet pipe 11. The hydraulic module 1 further includes a hydraulic heat exchanger 16, a built-in water pump 17, an electric heating unit 18 and an external water pump 19. The hydraulic heat exchanger 16 includes a first joint connected with an outdoor unit high-pressure air pipe, a second joint connected with an outdoor unit liquid pipe, a third joint connected with the built-in water pump 17 and a fourth joint connected with the electric heating unit 18. An inlet of the built-in water pump 17 is connected with the water inlet pipe 11, an outlet of the electric heating unit 18 is connected with the water outlet pipe 12, and the external water pump 18 is arranged between the outlet ends of the floor heating coil pipes and the master two-way valve 13. The hydraulic module 1 of the present invention is simple in structure, which is conductive to saving the cost and lowering the mounting difficulty.

In a preferred implementation of the present invention, when the hydraulic module 1 operates in the cooling mode, the built-in water pump 17 and the external water pump 18 are controlled to be started, the separate valve elements 20 corresponding to a heating room and a shut-down room respectively are controlled to be closed, and the separate valve element 20 corresponding to a cooling room is controlled to be opened. In a specific embodiment of the present invention, a room having a cooling requirement is defined as the cooling room, a room having a heating requirement is defined as the heating room, a room having no cooling/heating requirement is defined as the shut-down room. When the hydraulic module 1 operates in the heating mode, the built-in water pump 17 and the external water pump 18 are controlled to be started, the separate valve elements 20 corresponding to the cooling room and the shut-down room respectively are controlled to be closed, and the separate valve element 20 corresponding to the heating room is controlled to be opened. Through the above manner, in different modes, the room temperature in each room may be controlled through opening and closing of the separate valve elements 20 according to the cooling and heating requirements of the different rooms, so that a plurality of temperature zones are controlled respectively.

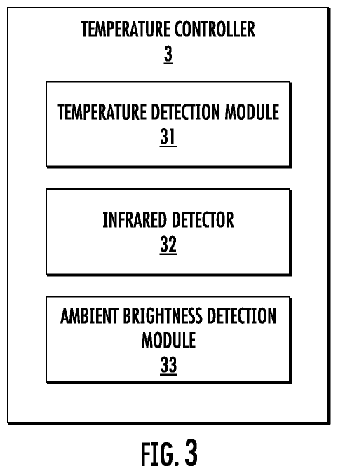

In a preferred implementation of the present invention, as shown in FIG. 3, the temperature controller 3 includes a temperature detection module 31 which is configured to detect the room temperature in each room. The control module 4 is configured to: control opening and closing of the separate valve element 20 in each room according to a comparison result of the room temperature in each room and the corresponding set temperature, and control the hydraulic module 1 to shut down when the room temperatures in all the rooms reach the set temperature. In a specific embodiment of the present invention, the temperature detection module 31 is a temperature probe. Through the above manner, when the room temperatures reach the set temperature, the separate valve elements 20 are closed to lower energy consumption output of the hydraulic module 1, which is conductive to saving the energy consumption; and when all the room temperatures reach the set temperature, the hydraulic module 1 is shut down, which is conductive to lowering the system energy consumption and improving the economy.

In a preferred implementation of the present invention, when a difference value between the room temperature in each room and the set temperature is greater than a second temperature preset value (may be set on the temperature controllers 3) and lasts for a predetermined period of time, the temperature controller 3 in the room sends a request to the hydraulic module 1, and the hydraulic module 1 is controlled to increase the amount of heating/cooling by modifying a set temperature correction value and controlling the built-in water pump 17 to be fixed to a maximum gear. The amount of cooling or heating is increased by modifying the set temperature correction value and fixing the built-in water pump 17 to the maximum gear, so that the water temperature increasing or decreasing rate can be increased to meet user requirements. In an example, the control module 4 sets 60° C. for water output, after a person exits from a room or at nightfall, the temperature controllers 3 send data to the hydraulic module 1 to start modification (taking modification of 2° C. as an example), and the preset water outlet temperature value in actual operation of the hydraulic module 1 is 58° C.

Continuing to refer to FIG. 3, in a preferred implementation of the present invention, the temperature controller 3 further includes an infrared detector 32 and an ambient brightness detection module 33, wherein the infrared detector 32 is configured to detect whether a person is in each room, and the control module 4 adjusts the set temperature or controls starting and shutdown of the hydraulic module 1 according to a detection result of the infrared detector 32. By judging whether a person is in a room, the set temperature is adjusted or starting and shutdown of the hydraulic module 1 are controlled, which is conductive to saving the energy consumption and improving the economy. The ambient brightness detection module 33 is configured to detect brightness in each room, and the control module 4 controls a rotating speed of an indoor fan (not shown in the figures) of the floor heating multi-split air conditioner, a rotating speed of the built-in water pump 17 and a rotating speed of the external water pump 19 according to a brightness detection result of the ambient brightness detection module 33. Specifically, when the brightness of a room is lower than a regulated value, the rotating speed of the indoor fan, the rotating speed of the built-in water pump 17 and the rotating speed of the external water pump 19 are lowered, which is conductive to further saving energy consumption and improving the economy. In a specific embodiment of the present invention, the ambient brightness detection module 33 is a photoresistor.

Further, when the infrared detectors 32 detect that there is no person in a room or the ambient brightness is lower than a preset value, the temperature controllers 3 send data to the hydraulic module 1 to start modifying the set temperature correction value, so that an actual operation temperature of the hydraulic module 1 is lower than the preset water outlet temperature value corresponding to the set temperature, and the energy consumption is lowered.

According to the present invention, by integrating the temperature detection modules 31, the infrared detectors 32 and the ambient brightness detection modules 33 in the temperature controllers 3, the utility of the temperature controllers 3 is improved, and through the temperature controllers integrating temperature detection, infrared detection and brightness detection functions, the hydraulic module 1 of the floor heating multi-split air conditioner can be made to operate in a more energy-saving mode, and the system energy consumption and the operating cost are lowered.

In a preferred implementation of the present invention, temperature detection units (TW-out, TW-in, T1 and T5) arranged at an outlet of the hydraulic heat exchanger 16, the water inlet pipe 11, the water outlet pipe 12 and the water tank 15 are further included, and specifically, the temperature detection units are temperature sensors and are configured to detect a water outlet temperature of the hydraulic heat exchanger, a water inlet temperature of the hydraulic module 1, a water outlet temperature of the hydraulic module 1 and a temperature of the water tank.

In a preferred implementation of the present invention, an expansion valve arranged between the water inlet pipe 11 and the built-in water pump 17, a water flow switch arranged at an outlet of the electric heating unit 18, an exhaust valve close to the water flow switch and a safety valve arranged at the outlet of the electric heating unit 18 with the exhaust valve are further included, so that the operating reliability of the hydraulic module 1 is improved.

In a preferred implementation of the present invention, the control module 4 is configured to: set starting time and a starting period of a domestic hot water mode operated by the hydraulic module 1, and control the master two-way valve 13 and the external water pump 19 to be closed and shut down and control the master three-way valve 14 to be opened during the starting time. Through the above manner, the domestic hot water mode may be operated regularly according to needs to obtain domestic hot water, and the use convenience is improved; and manual intervention is reduced. Specifically, a water inlet pipe of the water tank 15 communicates with the master three-way valve 14, and a water outlet pipe of the water tank 15 communicates with the water inlet pipe 11 of the hydraulic module 1. An auxiliary electric heating unit is arranged in the water tank 15. An outlet side of the water tank 15 is connected with user side water, and an inlet side of the water tank 15 communicates with a tap water pipeline so as to conveniently supplement water into the water tank 15 according to needs.

It should be noted that, the floor heating multi-split air conditioner connected with the hydraulic module 1 includes a compressor (not shown in the figures), an indoor unit (not shown in the figures), an outdoor unit (not shown in the figures), the indoor fan (not shown in the figures), an outdoor fan (not shown in the figures), a four-way valve (not shown in the figures), a coolant pipeline (not shown in the figures) and other basic elements of an air conditioning system, they are common application forms in the art and are not repeated here, and the control module 4 may be configured as a master switch for operation of the floor heating multi-split air conditioner and the hydraulic module 1. In addition, the arrangement form or connection form of the temperature controllers 3 in the rooms is not limited in the implementations of the present invention.

Corresponding to the hydraulic module control system of the floor heating multi-split air conditioner of the present invention, the present invention additionally provides a control method of the above hydraulic module control system of the floor heating multi-split air conditioner, including the following steps:
setting a set temperature in each room and an operation mode of a hydraulic module;
setting preset water outlet temperature values under different modes of the hydraulic module; and
controlling the hydraulic module to operate according to operation modes set by temperature controllers and preset water outlet temperature values corresponding to the set temperatures, and
controlling a cooling mode or a heating mode to be operated preferentially according to a comparison result of an outdoor ambient temperature and a third temperature preset value when the hydraulic module simultaneously receives the operation modes of cooling and heating.

According to the present invention, through connection and control manners of the temperature controllers in the rooms and the hydraulic module as well as the control module and the hydraulic module, the temperature in each room is independently controlled, the system structure is simplified, the system cost is lowered, and cooling and heating are achieved through water circulation to improve the comfort of the system; and when different cooling/heating requirements of different rooms are received, the operation mode that is selected preferentially is judged in combination with the outdoor ambient temperature, so that different requirements of different rooms are met while the system energy consumption is lowered.

The above-mentioned embodiments are only preferred embodiments of the present invention, and do not limit the present invention in any form. Any person skilled in the art, without departing from the scope of the technical solution of the present invention, utilizes the technical content disclosed above to make more possible changes and modifications to the technical solution of the present invention, or modifications are not intended to limit equivalent embodiments of the present invention. Therefore, all equivalent changes made according to the idea of the present invention without departing from the content of the technical solution of the present invention should be included within the protection scope of the present invention.

1. A hydraulic module control system of a floor heating multi-split air conditioner, the floor heating multi-split air conditioner comprising a hydraulic module and a plurality of floor heating modules connected with the hydraulic module, and the plurality of floor heating modules being correspondingly arranged in a plurality of rooms, wherein the hydraulic module control system comprises: a control module and a plurality of temperature controllers corresponding to the plurality of rooms, wherein,
the temperature controllers are in signal connection with the hydraulic module, and are configured to set a set temperature in each room and an operation mode of the hydraulic module; and
the control module is in signal connection with the hydraulic module, and is configured to: set preset water outlet temperature values under the different operation modes of the hydraulic module; and control the hydraulic module to operate according to received operation modes set by the temperature controllers and preset water outlet temperature values corresponding to the set temperatures, and control the hydraulic module to operate in a cooling mode or a heating mode preferentially according to a comparison result of an outdoor ambient temperature and a first temperature preset value when both a cooling operation mode and a heating operation mode are received.

2. The hydraulic module control system of the floor heating multi-split air conditioner according to claim 1, wherein the hydraulic module comprises a water inlet pipe, a water outlet pipe, a master two-way valve, a master three-way valve and a water tank, an inlet end of each floor heating module communicates with the water outlet pipe, an outlet end of each floor heating module communicates with the water inlet pipe, each floor heating module is provided with a separate valve element, and the master three-way valve is connected with the water outlet pipe, the water tank and the inlet ends of the plurality of floor heating modules; the master two-way valve is connected with the outlet ends of the plurality of floor heating modules and the water inlet pipe; and
the hydraulic module further comprises a hydraulic heat exchanger, a built-in water pump, an electric heating unit and an external water pump, the hydraulic heat exchanger comprises a first joint connected with an outdoor unit high-pressure air pipe, a second joint connected with an outdoor unit liquid pipe, a third joint connected with the built-in water pump and a fourth joint connected with the electric heating unit, an inlet of the built-in water pump is connected with the water inlet pipe, an outlet of the electric heating unit is connected with the water outlet pipe, and the external water pump is arranged between the outlet end and the master two-way valve.

3. The hydraulic module control system of the floor heating multi-split air conditioner according to claim 2, wherein when the hydraulic module operates in the cooling mode, the built-in water pump and the external water pump are controlled to be started, the separate valve elements corresponding to a heating room and a shut-down room respectively are controlled to be closed, and the separate valve element corresponding to a cooling room is controlled to be opened; and
when the hydraulic module operates in the heating mode, the built-in water pump and the external water pump are controlled to be started, the separate valve elements corresponding to the cooling room and the shut-down room respectively are controlled to be closed, and the separate valve element corresponding to the heating room is controlled to be opened.

4. The hydraulic module control system of the floor heating multi-split air conditioner according to claim 1, further comprising a temperature detection module, configured to detect a room temperature in each room; wherein
the control module is configured to: control opening and closing of a separate valve element in each room according to a comparison result of the room temperature in each room and the corresponding set temperature, and control the hydraulic module to shut down when the room temperatures in all the rooms reach the set temperature.

5. The hydraulic module control system of the floor heating multi-split air conditioner according to claim 4, wherein when a difference value between the room temperature in each room and the set temperature is greater than a second temperature preset value and lasts for a predetermined period of time, the temperature controller in the room sends a request to the hydraulic module, and the hydraulic module increases the amount of heating/cooling by controlling and modifying a set temperature correction value and fixing the built-in water pump to a maximum gear.

6. The hydraulic module control system of the floor heating multi-split air conditioner according to claim 1, further comprising an infrared detector, configured to detect whether a person is in each room, wherein the control module adjusts the set temperature or controls starting and shutdown of the hydraulic module according to a detection result of the infrared detector.

7. The hydraulic module control system of the floor heating multi-split air conditioner according to claim 1, further comprising an ambient brightness detection module, configured to detect brightness in each room, wherein the control module controls a rotating speed of an indoor fan of the floor heating multi-split air conditioner, a rotating speed of the built-in water pump and a rotating speed of the external water pump according to a brightness detection result of the ambient brightness detection module.

8. The hydraulic module control system of the floor heating multi-split air conditioner according to claim 1, wherein the control module is further configured to: set starting time and a starting period of a domestic hot water mode operated by the hydraulic module, and control the master two-way valve and the external water pump to be closed and shut down and control the master three-way valve to be opened during the starting time.

9. A control method of the hydraulic module control system of the floor heating multi-split air conditioner according to claim 1, comprising the following steps:
setting a set temperature in each room and an operation mode of a hydraulic module;
setting preset water outlet temperature values under different operation modes of the hydraulic module; and controlling the hydraulic module to operate according to the operation modes set by temperature controllers and preset water outlet temperature values corresponding to the set temperatures, and controlling a cooling mode or a heating mode to be operated preferentially according to a comparison result of an outdoor ambient temperature and a third temperature preset value when the hydraulic module simultaneously receives the operation modes of cooling and heating.
